(19) United States
(12) Patent Application Publication
(10) Pub. No.: US 2010/0146345 A1
(43) Pub. Date: Jun. 10, 2010

(54) INFORMATION PROCESSING APPARATUS, RECORDING MEDIUM INCLUDING PROGRAM FOR INFORMATION PROCESSING APPARATUS, AND METHOD OF CONTROLLING INFORMATION PROCESSING APPARATUS

(75) Inventor: Takashi Matsuda, Kawasaki (JP)

Correspondence Address: STAAS & HALSEY LLP, SUITE 700, 1201 NEW YORK AVENUE, N.W., WASHINGTON, DC, 20005, US

(73) Assignee: Fujitsu Limited, Kanagawa (JP)

(21) Appl. No.: 12/632,607

(22) Filed: Dec. 7, 2009

(30) Foreign Application Priority Data
Dec. 8, 2008 (JP) 2008-312613

(51) Int. Cl. G06F 11/00; G06F 15/173; G06F 11/07

(52) U.S. Cl. 714/48; 709/224; 714/E11.024

(57) ABSTRACT

An information processing apparatus includes a communication unit that communicates with another information processing apparatus, a memory device that holds data for communication by the communication unit, a processing unit that acquires a memory capacity of the memory device desirable for communication by the communication unit, a resource shortage information save and report unit that holds resource shortage information in the memory device and reports the resource shortage information when the processing unit fails to acquire the memory capacity, a resource shortage information reference unit that reads the resource shortage information held in the memory device, and an error output unit that outputs the resource shortage information read as an error by the resource shortage information reference unit.

### CROSS-REFERENCE TO RELATED APPLICATION

This application is based upon and claims priority to prior Japanese Patent Application No. 2008-312613 filed on Dec. 8, 2008 in the Japan Patent Office, the entire contents of which are incorporated herein by reference.

### FIELD

The present invention relates to an information processing apparatus, a recording medium including a program for the information processing apparatus, and a method of controlling the information processing apparatus.

### BACKGROUND

Methods have been proposed in which a control unit identifies a software module where a failure has occurred, and directs execution of processing for the failed software module in a case of a computer system resource shortage or in a case of occurrence of a software module failure during execution of an application by the computer system.

In addition, methods also have been proposed in which a comparison between resource information of an information processing apparatus itself and resource information necessary for starting an application is periodically made, and an insufficiency is displayed if a resource sufficient for starting the application is not secured.

[Patent Document 1] Japanese Laid-open Patent Publication No. 2003-256225

[Patent Document 2] Japanese Laid-open Patent Publication No. 2000-76085

### SUMMARY

According to an aspect of the invention, an information processing apparatus includes a communication unit that communicates with another information processing apparatus, a memory device that holds data for communication by the communication unit, a processing unit that acquires a memory capacity of the memory device desirable for communication by the communication unit, a resource shortage information save and report unit that holds resource shortage information in the memory device and reports the resource shortage information when the processing unit fails to acquire the memory capacity, a resource shortage information reference unit that reads the resource shortage information held in the memory device, and an error output unit that outputs the resource shortage information read as an error by the resource shortage information reference unit.

### BRIEF DESCRIPTION OF THE DRAWINGS

FIG. 1 illustrates a view explaining an operation flow depicting a method of outputting a socket shortage state according to an embodiment;

FIG. 2 illustrates a view explaining a configuration according to the embodiment;

FIG. 3 illustrates a block diagram explaining a hardware configuration of an information processing apparatus according to the embodiment;

FIG. 4 illustrates a block diagram explaining a software configuration of the information processing apparatus according to the embodiment;

FIG. 5 illustrates a flowchart (a first procedure) explaining details of an operation flow depicting the method of outputting the socket shortage state according to the embodiment;

FIGS. 6A and 6B illustrate flowcharts (second procedures) explaining details of the operation flow depicting the method of outputting the socket shortage state according to the embodiment;

FIG. 7A illustrates a view explaining a configuration example depicting a system-wide socket shortage state save area and FIG. 7B illustrates a view explaining a configuration example depicting a server socket user dedicated save area;

FIG. 8 illustrates a view indicating an example of contents displayed on a display by the information processing apparatus according to the embodiment;

FIG. 9 illustrates a view indicating an example of an output when the contents displayed on the display illustrated in FIG. 8 are output as a written report; and

FIG. 10 illustrates a view explaining a position of a socket processing unit in a layered structure of protocols in the information processing apparatus according to the embodiment.

### DESCRIPTION OF EMBODIMENTS

In an information processing apparatus disclosed in an embodiment, a so-called “socket interface” is used in performing communication complying with Transmission Control Protocol/Internet Protocol (TCP/IP) and User Datagram Protocol/Internet Protocol (UDP/IP). Here, the socket interface is also called a socket API. “API” is an acronym of an Application Programming Interface. To achieve a function of a socket complying with the socket interface, a memory capacity desirable for the function of the socket is acquired in advance. However, due to a shortage (or the like) of the memory capacity included in the information processing apparatus, there may be a case where acquisition of the memory capacity desirable for the function of the socket is difficult. Hereinafter, a state where it is difficult to acquire the memory capacity desirable for the function of the socket due to reasons, such as a shortage or the like of the memory capacity included in the information processing apparatus, is referred to as a “socket resource shortage.” In addition, hereinafter, acquiring the memory capacity desirable for the function of the socket is referred to as a “socket acquisition.”

The information processing apparatus disclosed in the embodiment includes a structure capable of reporting the state of a socket resource shortage to a user as error information upon occurrence of the socket resource shortage. Note that, as a method of acquiring a socket serving as a system resource, a method has been discussed in which acquisition of the whole size of a memory area is conducted so as to acquire the socket immediately after starting the information processing apparatus. Furthermore, as another method thereof, a method has been discussed in which acquisition of an infinite memory capacity is conducted later when the socket acquisition is needed. In a description of the embodiment hereinafter disclosed, the description is made for the former case. That is to say, the description of the embodiment is made for the case where the method of acquiring the whole size of the memory area so as to acquire the socket immediately after the start of the information processing apparatus is used.

Upon an occurrence of a socket resource shortage, an error concurrently occurs in an application (which, hereinafter, may be referred to as a “socket application”) which has accessed a socket processing unit that provides a function complying with the socket interface. However, there may be a case where it is difficult to identify a cause of the error from the contents of the error. On the other hand, it is assumed that correction of all the socket applications for the purpose of identifying the cause from an error message from the socket application is difficult.

To address the problem discussed above, the embodiment provides a way by which a system administrator of the information processing apparatus is capable of easily checking the state in which the socket resource shortage has occurred without correcting all the socket applications. Furthermore, the embodiment provides a way by which a state in which the socket resource shortage has occurred is capable of being checked afterward while a system of the information processing apparatus is automatically restored, if a temporary socket resource shortage has occurred. As a result thereof, a review, such as a re-estimation or the like, associated with the memory capacity desirable for the socket acquisition is capable of being conducted. In consequence, a reoccurrence of the same or similar problem may be prevented.

As disclosed above, a memory area to achieve the function of the socket is used after being developed on a memory included in the information processing apparatus. However, there may be a case where the socket resource shortage occurs due to a shortage of memory or the like because of the execution of other software. In this embodiment, a fact that a socket resource shortage has occurred is saved in a control information area in the system of the information processing apparatus. Note that the “control information area” means a system-wide socket shortage state save area 51 and a server socket user dedicated save area 52 both disclosed below. Furthermore, a mechanism, which is capable of immediately checking the state of the socket resource shortage by the system administrator who executes a reference command (which, hereinafter, may be referred to as a “DSPTCPS”), is provided. In addition, at the same time, an error is reported to the system administrator. That is, contents representing the error are displayed on a display of the information processing apparatus, without use of the socket application, upon occurrence of the socket resource shortage. In addition, the system administrator is capable of checking the state of the socket resource shortage afterward by executing the reference command at any time. As a result thereof, a reduction in time for analyzing and researching the cause or causes of a problem upon the occurrence of the socket resource shortage, the re-estimation of the memory capacity desirable for the socket acquisition, and so on may be conducted with ease. Moreover, using the socket interfaces to correct the socket applications themselves, which employ a network, is not necessary in the embodiment. Consequently, in the embodiment, it is possible to provide functions for reporting reference commands and errors so that compatibility among the socket applications may be secured.

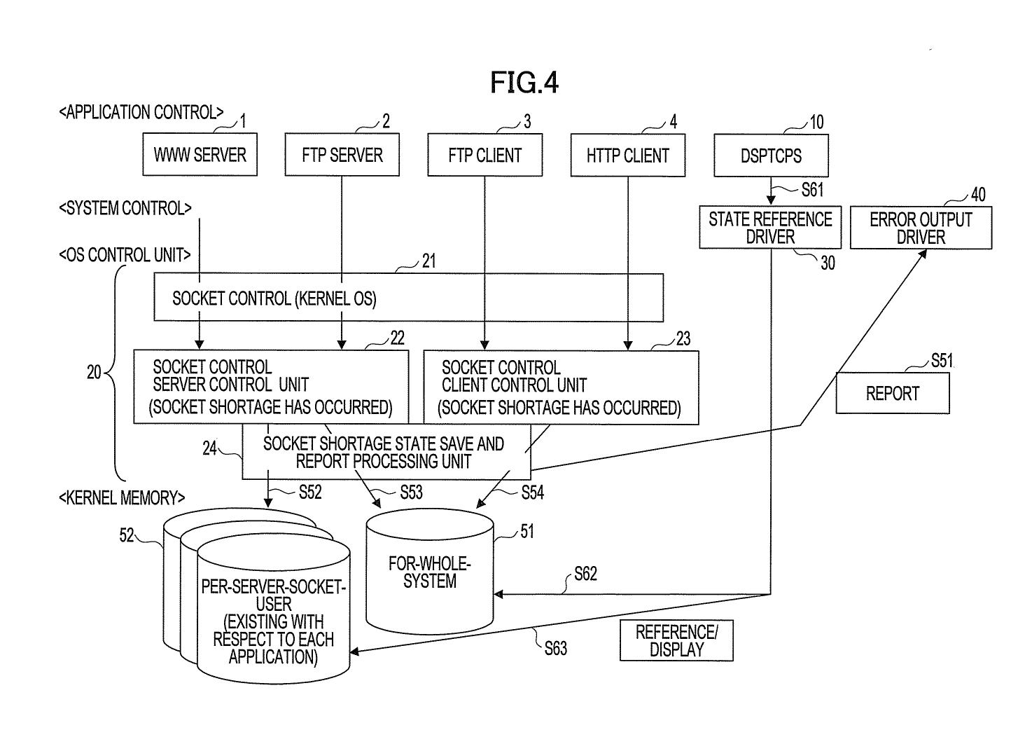

According to the embodiment, as disclosed above, if the socket resource shortage has occurred, the fact of the occurrence of the socket resource shortage is saved in the control information area in the system of the information processing apparatus. This control information area is disposed in a memory area that is included in a kernel of an operating system (OS) in which stored information is held until the system is restarted after the previous start. For this type of control information area, there is one system-wide socket shortage state save area, and there is one server socket user dedicated save area with respect to each of the server socket users. Note here that the server socket means the socket used in processing a service request. Application server software that serves as the server socket user and is installed in the information processing apparatus may include, for example, a World Wide Web server (WWW server), a File Transfer Protocol server (FTP server), and so on (see FIG. 4). Furthermore, the system-wide socket shortage state save area is disposed in an information storing area in which saved information is held even after a function of the network with which the information processing apparatus is connected has stopped.

Here, in this embodiment, if a socket resource shortage has occurred in performing client communication with use of the information processing apparatus, the fact of the socket resource shortage is saved in the system-wide socket shortage state save area. Note that client communication means a type of communication in which the information processing apparatus functions as a client. On the other hand, if a socket resource shortage has occurred in performing server communication with use of the information processing apparatus, the fact of the socket resource shortage is saved in both save areas, that is, the system-wide socket shortage state save area and the server socket user dedicated save area. At the same time, in order to report the fact of the occurrence of the socket resource shortage as an error to the system administrator of the information processing apparatus, the indication of the error is displayed on the display of the information processing apparatus, without use of the socket application, upon occurrence of the socket resource shortage.

In the information processing apparatus according to the embodiment, as disclosed above, the system-wide socket shortage state save area saves the fact of the occurrence of the socket resource shortage even after the stop of the function of the network. For this reason, the fact of the occurrence of the socket resource shortage is capable of being referenced not only immediately after occurrence of the error due to the socket resource shortage, but also at any time afterward.

In addition, the fact of the occurrence of the socket resource shortage that has been saved in the server socket user dedicated save area is capable of being referenced whenever the corresponding server socket is in operation. Referencing the fact of the occurrence of the socket resource shortage allows the corresponding socket application to be identified or the like. That is, this allows detailed analysis to be conducted.

Moreover, information, which includes the fact of the occurrence of the socket resource shortage, is not only capable of being referenced with use of the display of the information processing apparatus, but is also capable of being output as a written report in the information processing apparatus according to the embodiment. Thus, this allows checks for problems or the like to be conducted with ease.

Furthermore, since it is not only possible to reference the information, which includes the saved fact of the socket resource shortage, but also to output the information as a written report by execution of the reference command (e.g., DSPTCPS), system loads and system performance during normal operation of the information processing apparatus is not influenced.

Moreover, even if the function of the network, with which the information processing apparatus is connected, has been stopped, the fact of the occurrence of the socket resource shortage is capable of being referenced or relocated afterward. Thus, addressing the problem in a prompt manner, re-estimation of the memory area (that is, a system resource of the information processing apparatus) used in achieving the function of the socket, and so on are possible.

Furthermore, since the cause may be identified from the error message by the socket application, it is not necessary to correct the socket applications according to the embodiment.

The embodiment disclosed above is intended for the case where the acquisition of the memory capacity for achieving the function of the socket is failed so that a socket resource shortage is caused. Note however that the embodiment is also applicable, by using the same or a similar configuration, to cases where any error has occurred due to other causes, such as, a shortage of the network's buffer capacities used for communication or the like. That is, referencing the fact may be achieved with ease without changing the corresponding application by providing a function of saving the fact that the resource shortage has occurred due to a failure in acquiring the desirable memory capacity.

The information processing apparatus according to the embodiment displays an error message from the socket application on the display of the information processing apparatus in response to the reporting of the error to the socket application due to the socket resource shortage. The reference command is executed in a case where a cause of the error is not identified from the error message, and this allows the information that includes the saved fact of the socket resource shortage to be referenced on the display of the information processing apparatus or causes the information processing apparatus to print a written report.

When the saved fact of the socket resource shortage is held in the server socket user dedicated save area, it is possible to determine that the socket resource shortage has occurred during an operation related to communication by the corresponding socket application. As a result thereof, determination on whether the corresponding server socket is overused or not in comparison with the number and the amount of the server sockets based on an initial estimate is made, and the subsequent operation, the re-estimation and so on may be conducted in response to a result of the determination. On the other hand, when the saved fact of the socket resource shortage is held only in the system-wide socket shortage state save area, it is difficult to identify the socket application in which the error has occurred. In the latter case, it is possible to perform a check again whether the estimate of the number of sockets, disposed for the whole system of the information processing apparatus, is proper or not.

Hereinafter, a configuration of the above embodiment will be disclosed in detail with reference to drawings.

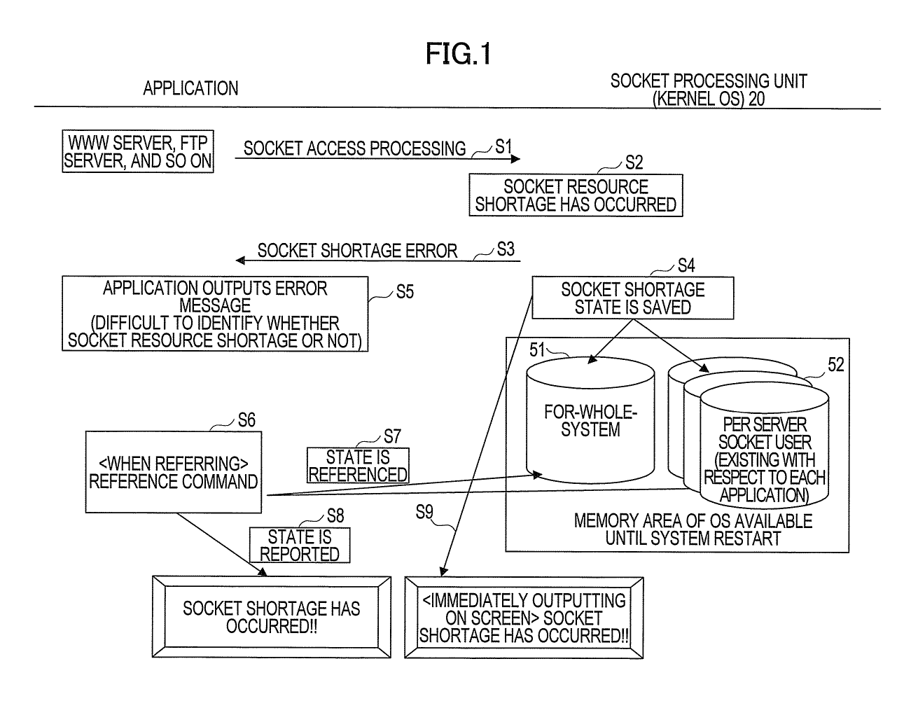

FIG. 1 illustrates a view explaining an operation flow depicting a socket shortage state output method executed by the information processing apparatus according to the embodiment. The “application” in FIG. 1 means an application included in the information processing apparatus. Moreover, a socket processing unit 20 (also referred to as a “socket driver”) is a program disposed in the kernel of the operating system (OS) of the information processing apparatus. This socket processing unit 20 provides socket functions complying with the socket interface.

In FIG. 1, a server (that is, the socket application) included in the information processing apparatus accesses the socket processing unit 20 so as to perform communication with use of the socket interface in Operation S1. Assume that a socket resource shortage state has occurred (Operation S2). In the above case, an error is reported from the socket processing unit 20 to the socket application (Operation S3). At the same time, the socket processing unit 20 saves the fact of the socket resource shortage either in the system-wide socket shortage state save area 51 and the server socket user dedicated save area 52 or in the system-wide socket shortage state save area 51 (Operation S4). In addition, at the same time, the fact of the occurrence of the socket resource shortage is displayed on the display of the information processing apparatus without use of the socket application (Operation S9). Here “per-server-socket-user” means “with respect to each socket application” and the server socket user dedicated save area 52 includes a discrete memory area with respect to each of the socket applications.

On the other hand, thereafter, execution of the reference command (Operation S6) by the system administrator causes the following operations to be executed. That is, the system-wide socket shortage state save area 51 and the server socket user dedicated save area 52 are referenced (Operation S7). As a result of Operation S7, when the fact of the occurrence of the socket resource shortage is held either in the system-wide socket shortage state save area 51 and the server socket user dedicated save area 52 or in the system-wide socket shortage state save area 51, the information that includes the fact is displayed on the display of the information processing apparatus (Operation S8).

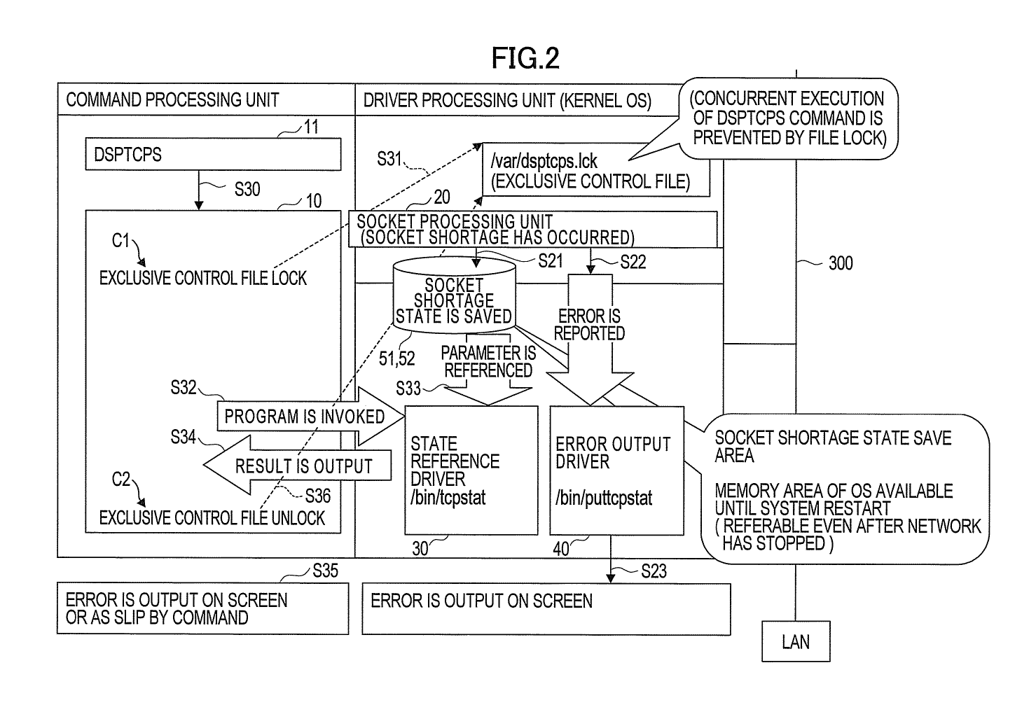

FIG. 2 illustrates a block diagram in which parts related to the above operation by referring to FIG. 1 are extracted and indicated, among the software included in the information processing apparatus according to the embodiment. As illustrated in FIG. 2, the software of the information processing apparatus according to the embodiment includes a reference command processing unit 10 as a command processing unit, and the socket processing unit 20. In addition, the system-wide socket shortage state save area 51 and the server socket user dedicated save area 52 are used by the software. The reference command processing unit 10 is a program that is executed by the execution of a reference command 11. The software of the information processing apparatus according to the embodiment further includes a state reference driver 30 and an error output driver 40. Among the respective programs, the reference command processing unit 10 belongs to a command processing unit, and the socket processing unit 20, the state reference driver 30, and the error output driver 40 belong to a driver processing unit.

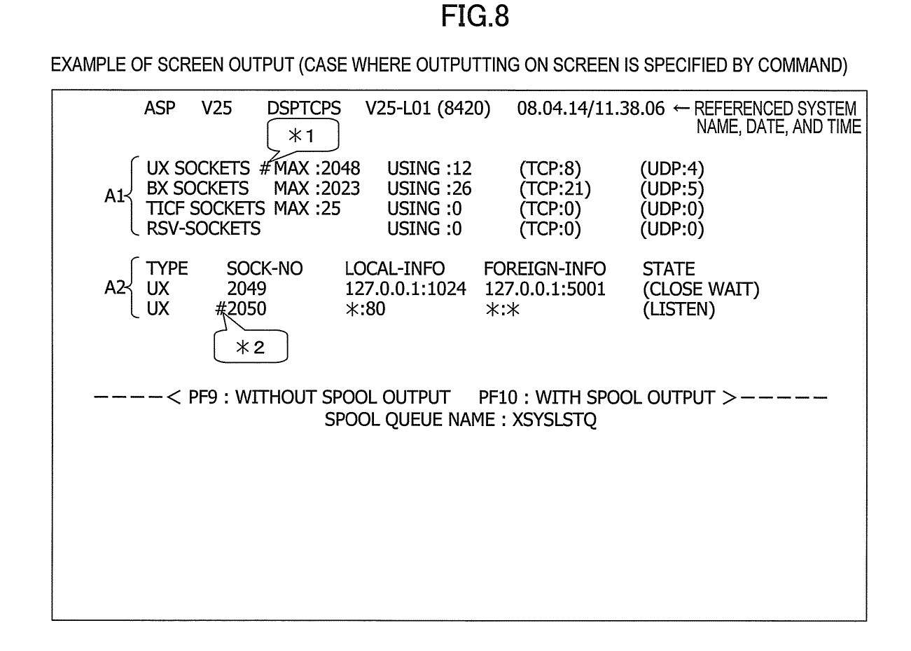

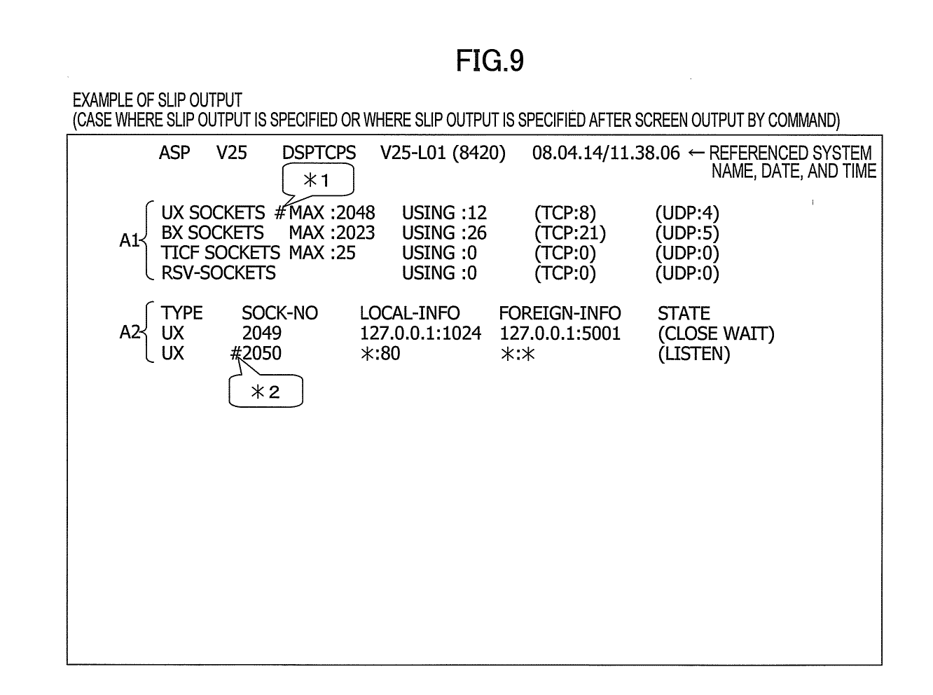

The reference command processing unit 10 is executed based on the execution of the reference command 11 by the system administrator. The reference command processing unit 10 includes the function of displaying a current state of the socket generated by a function complying with the socket interface or the function of printing the written report. The state reference driver 30 is executed by the reference command processing unit 10, and information, which indicates the current state of the above socket is acquired by the state reference driver 30 referencing the server socket user dedicated save area 52, whereby the information is output to the reference command processing unit 10. The reference command processing unit 10 displays the information indicating the current state of the socket on the display or prints the information as the written report (see FIGS. 8 and 9 described later).

Upon receipt of an error reported from the kernel of the OS, the error output driver 40 directly displays the error on the display of the information processing apparatus without use of the application.

An operation flow of the information processing apparatus according to the above embodiment by referring to FIG. 1 will be disclosed in relation to operations of the respective programs illustrated in FIG. 2.

Upon an occurrence of a socket resource shortage during execution of the socket processing unit 20, a fact of the socket resource shortage is saved either in the system-wide socket shortage state save area 51 and the server socket user dedicated save area 52 or in the system-wide socket shortage state save area 51 (Operation S21). Then, the fact of the occurrence of the socket resource shortage is reported to the error output driver 40 (Operation S22), the error output driver 40 receives the report, and the fact of the occurrence of the socket resource shortage is displayed, as an error, on the display of the information processing apparatus (Operation S23).

Thereafter, in response to an operation of executing the reference command 11 performed on the information processing apparatus by the system administrator (Operation S30), the reference command 10 is executed and an exclusive control file LOCK command C1 is executed. As a result thereof, an exclusive control file is locked (Operation S31), and subsequently, the execution of the reference command processing unit 11 is prevented until an exclusive control file UNLOCK command C2 is executed so as to unlock the exclusive control file (Operation S36). Next, the reference command processing unit 10 invokes the state reference driver 30 (Operation S32). In response to the invocation by the reference command processing unit 10, the state reference driver 30 references the system-wide socket shortage state save area 51 and the server socket user dedicated save area 52 (Operation S33). Next, the state reference driver 30 outputs the information acquired by referencing the system-wide socket shortage state save area 51 and the server socket user dedicated save area 52 (Operation S33) to the reference command processing unit 10 (Operation S34).

Here, the information acquired in Operation S33 by the state reference driver 30 having referenced the server socket user dedicated save area 52 is the information, indicating the current state of the socket generated by the function complying with the socket interface and information indicating the fact of the socket resource shortage related to a server operation. On the other hand, the information acquired in Operation S33 by the state reference driver 30 having referenced the system-wide socket shortage state save area 51 is information indicating the fact of the occurrence of the socket resource shortage related to the server operation and information indicating the fact of the socket resource shortage related to a client operation. The information acquired in Operation S33 based on the reference is output to the reference command processing unit 10 in Operation S34. The fact of the above socket resource shortage indicates the fact of the occurrence of the socket resource shortage saved either in the system-wide socket shortage state save area 51 and the server socket user dedicated save area 52 or in the system-wide socket shortage state save area 51 in Operation S21.

Thereafter, the reference command processing unit 10 either displays the information, which includes the fact of the occurrence of the socket resource shortage and is output from the state reference driver 30 in Operation S34, on the display of the information processing apparatus or prints the information as the written report (Operation S35). Here, for example, the information actually displayed on the display of the information processing apparatus or printed in the written report includes the contents as depicted later in FIGS. 8 and 9. That is, the fact of the occurrence of the socket resource shortage is either displayed or printed by using the function of displaying or printing the current state of the socket generated by the function complying with the socket interface.

Here, as a result of Operation S33 disclosed above, if the fact of the occurrence of the socket resource shortage is saved neither in the system-wide socket shortage state save area 51 nor in the server socket user dedicated save area 52, the following operations are performed. That is, the information acquired in Operation S33 by the state reference driver 30 referencing the system-wide socket shortage state save area 51 and the server socket user dedicated save area 52 in the case as disclosed above is such information that indicates the current state of the socket. Therefore, in the above case, the information indicating the current state of the socket is either displayed on the display of the information processing apparatus or printed as the written report.

That is, in the above case, contents without a sign “#” (representing the fact of the occurrence of the socket resource shortage) being indicated is either displayed on the display or printed as the written report as depicted later in FIGS. 8 and 9.

Finally, the reference command processing unit 10 executes the exclusive control file UNLOCK command C2 (Operation S36) to unlock the exclusive control file. Thereafter, the reference command 11 becomes executable.

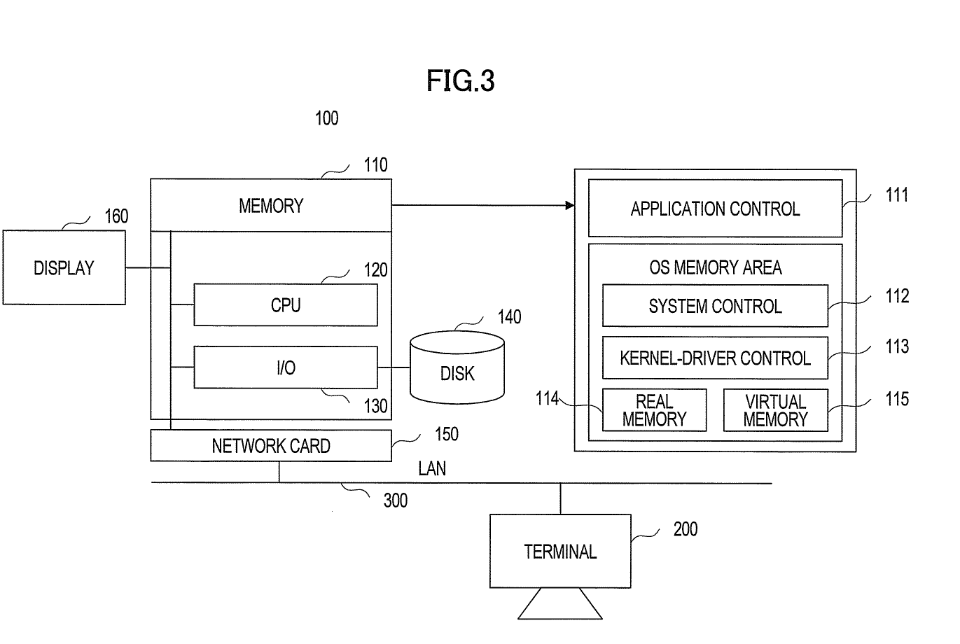

FIG. 3 illustrates a block diagram explaining a hardware configuration of the information processing apparatus according to the embodiment.

As illustrated in FIG. 3, an information processing apparatus 100 according to the embodiment includes a central processing unit (CPU) 120, a memory 110, an input/output (I/O) unit 130, a display 160, an auxiliary memory unit 140, and a network card 150. The CPU 120 performs arithmetic and control operations. The memory (that is, a main memory unit) 110 stores a variety of programs executed by the CPU 120 and a variety of data processed by the CPU 120. The I/O unit 130 provides an interfacing function of sending and receiving the data between the auxiliary memory unit 140 and the CPU 120. The auxiliary memory unit 140 provides an auxiliary function for the memory unit 110. The network card 150 provides an interfacing function related to connection with a local area network (LAN) 300. The information processing apparatus 100 is coupled to, for example, another terminal (that is, the other information processing apparatus) 200 via the LAN 300.

The memory 110 includes an application control unit 111 and an OS memory area. The application control unit 111 stores a variety of application programs. The OS memory area includes a system control unit 112, a kernel drive control unit 113, a real memory 114, and a virtual memory 115. The system control unit 112 stores a program responsible for control of the whole system of the information processing apparatus 100. The kernel drive control unit 113 stores the OS that includes the kernel. The real memory 114 and the virtual memory 115 store a variety of data.

FIG. 4 illustrates the variety of programs stored in the memory 110 in FIG. 3. Note that the variety of programs illustrated in FIG. 4 indicates parts mainly associated with the operations explained by referring to FIGS. 1 and 2 among the variety of programs stored in the memory 110. Note, in addition, that a variety of server software illustrated in FIG. 4 is merely an example, and a server installed in the information processing apparatus 100 is not limited to the server software as disclosed in the embodiment.

As illustrated in FIG. 4, the application control unit 111 stores a WWW server 1, an FTP server 2, an FTP client 3, and a HyperText Transfer Protocol (HTTP) client 4. Among these socket applications, the WWW server 1 and the FTP server 2 are socket applications that perform the server operations, and the FTP client 3 and the HTTP client 4 are socket applications that perform client operations. In addition, the application control unit 111 includes the reference command processing unit 10 disclosed by referring to FIG. 2.

The system control unit 112 includes the state reference driver 30 and the error output driver 40 disclosed by referring to FIG. 2.

The kernel drive control unit 113 includes the socket processing unit 20 disclosed by referring to FIG. 2. The socket processing unit 20 includes a socket control unit 21, a server control unit 22, a client control unit 23, and a socket shortage state save and report processing unit 24. The socket control unit 21 includes a function of controlling, as a whole or in a comprehensive manner, a function of a socket interface provided by the socket processing unit 20. The server control unit 22 provides the function of the socket interface for the socket applications performing the server operation. The client control unit 23 provides the function of the socket interface for the socket applications performing the client operation. The socket shortage state save and report processing unit 24 provides a function of performing the operation of saving the fact of the occurrence of the socket resource shortage in Operation S21 and the operation of reporting the fact of the occurrence of the socket resource shortage in Operation S22 both disclosed in FIG. 2.

The real memory 114 and the virtual memory 115 disclosed above include the system-wide socket shortage state save area 51 and the server socket user dedicated save area 52 disclosed by referring to FIGS. 1 and 2. That is, the system-wide socket shortage state save area 51 and the server socket user dedicated save area 52 are included in the information storing area used by the kernel of the OS. As disclosed above, here, the “socket acquisition” means “acquisition of the memory capacity desirable for a function of a socket.” Furthermore, the memory capacity desirable for the function of the socket is acquired from the above real memory 114. This memory capacity is acquired from the real memory 114 upon start of the system. The server socket user dedicated save area 52 is used as a part of the memory capacity thus acquired.

Hereinafter, among the operations disclosed by referring to FIGS. 1 and 2, parts associated with the respective programs illustrated in FIG. 4 will be disclosed.

In response to a socket resource shortage occurred in the server control unit 22 or in the client control unit 23, the socket shortage state save and report processing unit 24 reports the fact of the socket resource shortage to the error output driver 40 (Operation S51). This operation corresponds to the operation performed in Operation S22 in FIG. 2. Thereafter, the error output driver 40 displays the fact of the occurrence of the socket resource shortage as an error on the display (that is, the display 160 illustrated in FIG. 3) of the information processing apparatus, without use of the socket application, based on the operation performed in Operation S23 illustrated in FIG. 2.

Moreover, in response to the socket resource shortage having occurred in the server control unit 22, the socket shortage state save and report processing unit 24 saves the fact of the occurrence of the socket resource shortage in both the system-wide socket shortage state save area 51 and the server socket user dedicated save area 52 (Operations S52 and S53). This operation corresponds to the operation performed in Operation S21 in FIG. 2.

In addition, in response to the socket resource shortage occurred in the client control unit 23, the socket shortage state save and report processing unit 24 saves the fact of the occurrence of the socket resource shortage in the system-wide socket shortage state save area 51 (operation S54). This operation corresponds to the operation performed in Operation S21 in FIG. 2.

In addition, the execution of the reference command processing unit 10 causes the state reference driver 30 to be invoked based on the operation performed in Operation S32 in FIG. 2. As a result thereof, the state reference driver 30 reads the following information either from the system-wide socket shortage state save area 51 and the server socket user dedicated save area 52 or from the system-wide socket shortage state save area 51. That is, the state reference driver 30 reads the fact of the occurrence of the socket resource shortage or the information that includes the fact of the occurrence of the socket resource shortage (Operations S62 and S63). This operation corresponds to the operation performed in Operation S33 in FIG. 2. Thereafter, the operation performed in Operation S35 in FIG. 2 causes the information that includes the fact of the occurrence of the socket resource shortage to be displayed on the display of the information processing apparatus or to be printed as the written report. The information which includes the fact of the occurrence of the socket resource shortage means information that includes the fact of the occurrence of the socket resource shortage and indicates the current state of the socket generated by the function complying with the socket interface (see FIGS. 8 and 9 illustrated later).

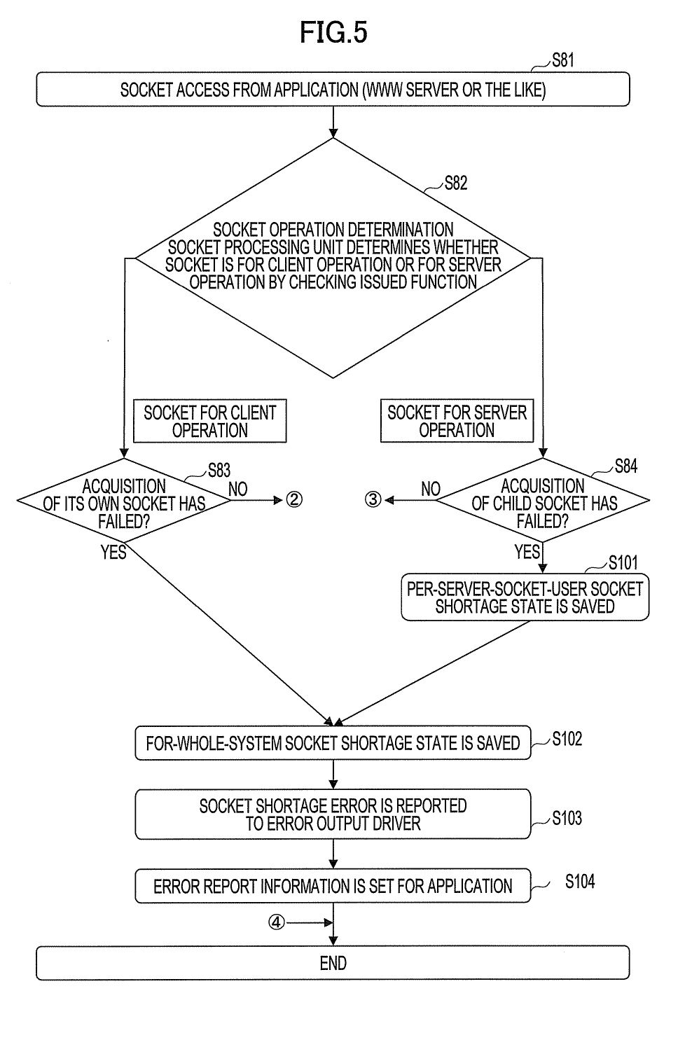

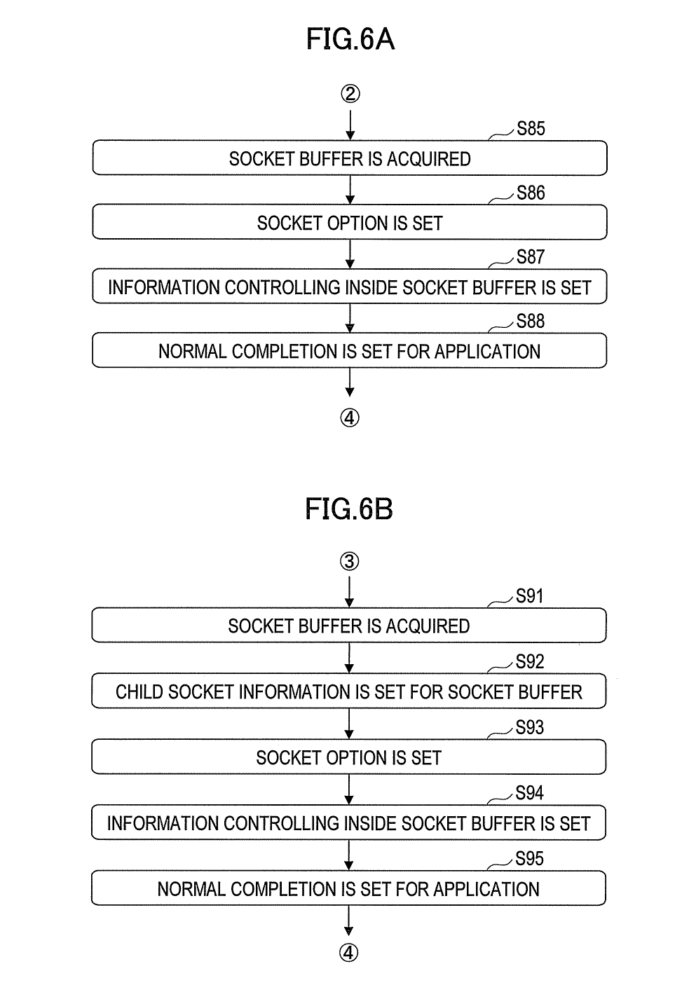

Next, detailed operations of the information processing apparatus 100 explained by referring to FIGS. 1, 2, and 4 will be disclosed with reference to FIG. 5 and FIGS. 6A and 6B.

An access for using a socket is made to the socket processing unit 20 from the application program (that is, the socket application) stored in the application control unit 111 in Operation S81 illustrated in FIG. 5. Upon being accessed by the socket application, the socket control unit 21 of the socket processing unit 20 analyzes contents of the access and determines whether the socket related to this access is a socket for the client operation or a socket for the server operation (Operation S82). Here, when communication related to this access from the application is communication for performing the client operation, the client control unit 23 generates a socket for the client operation. On the other hand, when communication related to this access from the application is communication for performing the server operation, the server control unit 22 generates a child socket for the server operation (disclosed later).

When a result of the determination in Operation S82 is “socket for the client operation”, the client control unit 23 tries to acquire the socket for the client operation. When the client control unit 23 fails to acquire the socket, the process goes to Operation S102, and when the client control unit 23 succeeds in acquiring the socket, the process goes to Operation S85 in FIG. 6A.

In Operation S102, the socket shortage state save and report processing unit 24 saves the fact of the socket acquisition failure, that is, the fact of the occurrence of the socket resource shortage, in the system-wide socket shortage state save area 51. Next, the socket shortage state save and report processing unit 24 reports the fact of the occurrence of the socket resource shortage to the error output driver 40, in Operation S103. Then, the socket control unit 21 makes settings for the socket application, having made access in Operation S81, so as to report the fact of the occurrence of the socket resource shortage as an error (Operation S104). Then, the socket control unit 21 terminates the series of operations started in Operation S81.

On the other hand, when a result of the determination in Operation S82 is “socket for the server operation”, the server control unit 22 tries to acquire the child socket for the server operation (disclosed later). When the server control unit 22 fails to acquire the socket, the process goes to Operation S101, and when the server control unit 22 succeeds in acquiring the socket, the process goes to Operation S91, in FIG. 6B. Note that the “child socket” is a socket that is individually generated upon receipt of a connection request from a client for the requested connection. That is, for the purpose of server operations, the socket for receipt of the connection request from the client is disposed, in advance, with respect to each server socket user (in other words, with respect to each socket application). Then, in response to the socket application's receiving the connection request from the client, the socket application accesses the socket processing unit 20 based on the operation performed in Operation S81. Upon being accessed by the socket application, the server control unit 22 of the socket processing unit 20 acquires the child socket for the connection related to the connection request (Operations S82 through S84).

In Operation S101, the socket shortage state save and report processing unit 24 saves the fact of the occurrence of the socket acquisition failure, that is, the fact of the occurrence of the socket resource shortage in the server socket user dedicated save area 52. As disclosed above, the server socket user dedicated save area 52 includes a discrete memory area with respect to each socket application. Therefore, in Operation S101, the socket shortage state save and report processing unit 24 saves the fact of the occurrence of the socket resource shortage in a memory area disposed for the socket application having made access in Operation S81.

Next, the socket shortage state save and report processing unit 24 saves the fact of the occurrence of the socket resource shortage in the system-wide socket shortage state save area 51 in Operation S102. Then, the fact of the occurrence of the socket resource shortage is reported by the socket shortage state save and report processing unit 24 to the error output driver 40 in Operation S103. Thereafter, the socket control unit 21 makes a setting for the socket application having made access in Operation S81 to report the fact of the occurrence of the socket resource shortage as an error (Operation S104). Then, the socket control unit 21 terminates the series of operations started in Operation S81.

In Operation S85 in FIG. 6A, the client control unit 23 acquires a socket buffer with respect to the socket related to the socket acquisition in Operation S83. Next, a desirable socket option is set for the socket by the client control unit 23 in Operation S86. Then, socket buffer internal control information is set by the client control unit 23 in Operation S87. Upon completion of Operations S85 through S87, the socket control unit 21 makes settings for the socket application to report the completion of the operations desirable for achieving the function of the socket interface (Operation S88). Thereafter, the socket control unit 21 terminates the series of operations started in Operation S81. Since the operations performed in Operations S85 through Operation S88 are the operations complying with the known socket interface, detailed description thereof will be omitted. Here, as disclosed above, “socket acquisition” means “acquisition of the memory capacity desirable for the function of the socket.” The “memory capacity desirable for the function of the socket” includes the memory capacity for storing the socket buffer acquired in Operation S85, the socket option set in Operation S86, and the information controlling inside the socket buffer set in Operation S87. The memory capacity is acquired from the real memory 114 and acquired with respect to each of the socket applications corresponding thereto.

In Operation S91 in FIG. 6B, the server control unit 22 acquires a socket buffer with respect to the child socket related to the acquisition of the socket in Operation S84. Next, child socket information is set for the socket buffer by the server control unit 22 in Operation S92. Then, a socket option desirable for the child socket is set by the server control unit 22 in Operation S93. Thereafter, information controlling inside the socket buffer is set by the server control unit 22 in Operation S94. Upon completion of Operations S91 through S94, the socket control unit 21 makes settings for the application to report the completion of the operations desirable for achieving the function of the socket interface (Operation S95). The socket control unit 21 terminates the series of operations started in Operation S81. Since the operations performed in Operations S91 through S95 are operations complying with the known socket interface, detailed description thereof will be omitted. Here, the “memory capacity desirable for the function of the socket” includes the memory capacity for storing the socket buffer acquired in Operation S91, the child socket information set in Operation S92, the socket option set in Operation S93, and the information controlling inside the socket buffer set in Operation S94. The memory capacity is acquired from the real memory 114 and acquired with respect to each of the socket applications corresponding thereto.

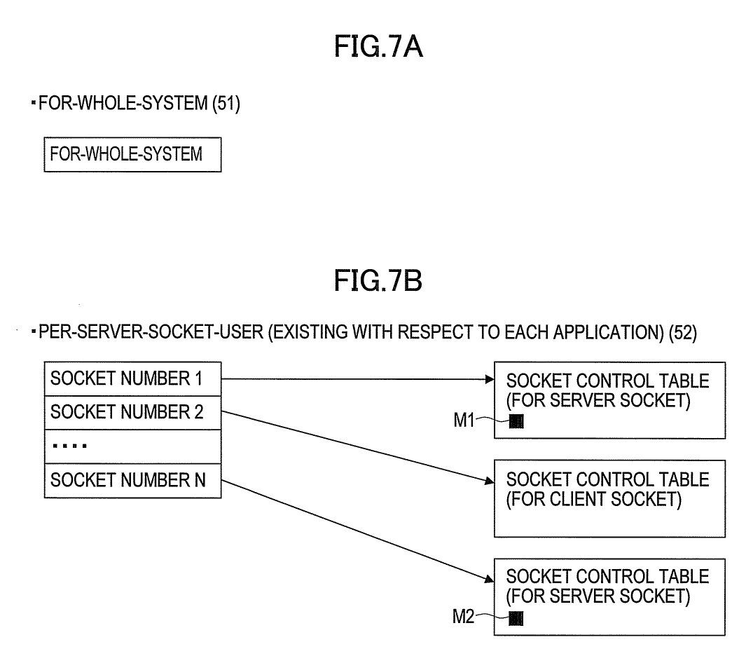

FIG. 7A illustrates a view explaining a configuration example of the system-wide socket shortage state save area 51 and FIG. 7B illustrates a view explaining a configuration example of the server socket user dedicated save area 52.

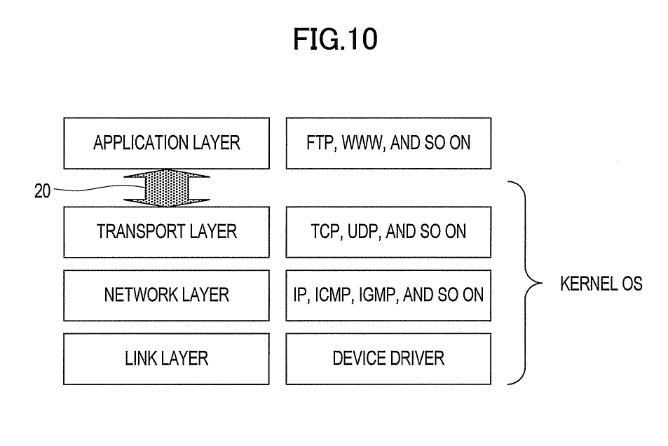

FIG. 7A illustrates the configuration example of the system-wide socket shortage state save area 51. The system-wide socket shortage state save area 51 is a unique area in the system of the information processing apparatus 100. Whether the socket resource shortage has occurred or not is set with use of ON and OFF. The system-wide socket shortage state save area 51 is initialized upon the start of the system of the information processing apparatus 100 by the socket shortage state save and report processing unit 24. In addition, the system-wide socket shortage state save area 51 is initialized by the socket shortage state save and report processing unit 24 upon activation of the socket processing unit 20 included in the kernel of the information processing apparatus 100 and corresponding to each of a transport layer, a network layer, and a link layer in FIG. 10.

FIG. 7B illustrates the configuration example of the server socket user dedicated save area 52. In the example of FIG. 7B, the configuration illustrated in FIG. 7B is disposed in each of the server socket user dedicated save areas 52 disposed with respect to each of the socket applications. As illustrated in FIG. 7B, a total of N sockets (the socket numbers 1 through N) are disposed in advance with respect to each of the socket applications. Moreover, as illustrated in FIG. 7B, a socket control table is disposed with respect to each of the N number of sockets. The socket control table functions as the “memory capacity desirable for the function of a socket” and the socket control table stores the socket buffer, the socket option, the information controlling inside the socket buffer, and so on, each related to the socket. Here, M1 and M2 in FIG. 7B indicate information display units (for example, bits) disposed so as to display the fact of the occurrence of the socket resource shortage. As illustrated in FIG. 7B, the information display units M1 and M2 are disposed only for the server sockets among the sockets. Whether or not the socket resource shortage has occurred is set for the information display unit with use of ON and OFF. Contents set for the information display unit are initialized by the socket resource shortage state save and report processing unit 24 with respect to each of the sockets upon the first use of the socket (that is, upon acquisition of the socket application). Moreover, the contents set for the information display unit are initialized by the socket shortage state save and report processing unit 24 with respect to each of the sockets upon the socket being released (that is, upon the stop of the execution of the socket application).

Next, examples of the displayed contents or the printed contents are explained by referring to FIGS. 8 and 9. The contents include the information which includes the fact of the occurrence of the socket resource shortage, that is displayed or printed according to the function of the reference command processing unit 10 and the state reference driver 30. FIG. 8 illustrates an example of the contents displayed on the display 160 of the information processing apparatus 100 as a result of the execution of the reference command 11. FIG. 9 illustrates the example of a written report that is printed by the information processing apparatus 100 when printing the written report is specified by execution of another command or when specified by a user while the information is displayed on the display 160.

In each of FIGS. 8 and 9, A1 indicates the total number of various sockets that are used, and A2 indicates the current state of the sockets with respect to each of the sockets. Note that, in each of FIGS. 8 and 9, only the states of two (2) sockets (the socket number 2049 and the socket number 2050) are indicated in A2. However, for example in A1, a total number of twelve (12) UX SOCKETS in the top row and a total of twenty-six (26) BX SOCKETS in the second row may be used in practice. That is, if the total number of sockets currently in use is thirty eight (38), as a result, the thirty-eight (38) rows corresponding thereto are displayed in A2. Note however that only two (2) rows are displayed in FIG. 9, and the illustration of the rest of thirty-six (36) rows is omitted.

In FIGS. 8 and 9, the signs “#” indicated with *1 and *2 represent the fact of the occurrence of the socket resource shortage. Here, the fact of the occurrence of the socket resource shortage indicated with *1 represents the socket resource shortage state in the whole system and is displayed according to the information saved in the system-wide socket shortage state save area 51. Here, as disclosed above, the system-wide socket shortage state save area 51 is initialized upon the start of the system or upon activation of the socket processing unit 20 included in the kernel of the information processing apparatus 100 and corresponding to each of the transport layer, the network layer, and the link layer in FIG. 10. Thus, the fact of the occurrence of the socket resource shortage indicated with *1 is capable of being referenced even after deactivation of the socket processing unit 20 included in the kernel in the information processing apparatus 100 and corresponding to each of the transport layer, the network layer, and the link layer in FIG. 10.

The fact of the socket resource shortage indicated with *2 represents the socket resource shortage state with respect to each server socket user and is displayed according to the information saved in the server socket user dedicated save area 52. Here, as disclosed above, contents set for the information display units M1 and M2, which are disposed in the server socket user dedicated save area 52, are initialized upon starting use of or upon releasing the corresponding socket. Therefore, referencing during the operation of the server socket indicated by *2 becomes possible.

Since the socket resource shortage state with respect to each server socket user indicated by *2 is displayed according to the information saved in the server socket user dedicated save area 52, the state reference driver 30 is capable of identifying the socket application related to the socket resource shortage. As a result thereof, it is possible to put the sign “#” indicating the socket resource shortage on the row that represents the state of the socket related to the corresponding application, in the contents illustrated in FIGS. 8 and 9. FIGS. 8 and 9 indicate cases where the corresponding socket application is the WWW server 1 illustrated in FIG. 4, and the sign “#” is put on the row with the port number “80” of the www server 1, as LOCAL-INFO. Here, LOCAL-INFO indicates local information of an own side in the corresponding communication, and FOREIGN-INFO indicates information of a counterpart side in the corresponding communication.

FIG. 10 illustrates a view explaining a position of the socket processing unit 20 in a layered structure of protocols in the information processing apparatus 100. As illustrated in FIG. 10, the protocols in the information processing apparatus 100 include an application layer, the transport layer, the network layer, and the link layer. The application layer includes, for example, the FTP server, the www server, and so on, as disclosed above. The transport layer includes Transmission Control Protocol (TCP), User Datagram Protocol (UDP), and so on. The network layer includes Internet Protocol (IP), Internet Control Message Protocol (ICMP), Internet Group Management Protocol (IGMP), and so on. The link layer includes a variety of device drivers. The socket processing unit 20 is disposed between the application layer and the transport layer, and provides the function complying with the known socket interface.

What is claimed is:

1. An information processing apparatus comprising:
a communication unit that communicates with another information processing apparatus;
a memory device that holds data for communication by the communication unit;
a processing unit that acquires a memory capacity of the memory device desirable for communication by the communication unit;
a resource shortage information save and report unit that holds resource shortage information in the memory device and reports the resource shortage information when the processing unit fails to acquire the memory capacity;
a resource shortage information reference unit that reads the resource shortage information held in the memory device; and
an error output unit that outputs the resource shortage information read as an error by the resource shortage information reference unit.

2. The information processing apparatus according to claim 1, wherein the memory device comprises:
a for-whole-system save area that saves the resource shortage information when the information processing apparatus performs communication, by using the communication unit, as a server which provides a service on a network or as a client which receives the service; and
a server socket user dedicated save area that saves the resource shortage information when the information processing apparatus performs communication as the server.

3. The information processing apparatus according to claim 2, wherein the memory device further comprises:
an information storing area that is used by a kernel of an operating system included in the information processing apparatus.

4. A computer readable medium including a program for an information processing apparatus that includes a communication unit, an arithmetic processing device, and a memory device, the program causing the arithmetic processing device to function as:
a processing unit that acquires a memory capacity of the memory device desirable for communication by the communication unit;
a resource shortage information save and report unit that holds resource shortage information in the memory device and reports the resource shortage information when the processing unit fails to acquire the memory capacity;
a resource shortage information reference unit that reads the resource shortage information held in the memory device; and
an error output unit that outputs the resource shortage information read as an error by the resource shortage information reference unit.

5. The computer readable medium including program according to claim 4, wherein the memory device comprises:
a for-whole-system save area that saves the resource shortage information when the information processing apparatus performs communication, by using the communication unit, as a server which provides a service on a network or as a client which receives the service; and
a server socket user dedicated save area that saves the resource shortage information when the information processing apparatus performs communication as the server.

6. The computer readable medium including program according to claim 5, wherein the memory device further comprises:
an information storing area that is used by a kernel of an operating system included in the information processing apparatus.

7. A method of controlling an information processing apparatus that includes a communication unit and an arithmetic processing device and a memory device, the method comprising:
acquiring a memory capacity of the memory device desirable for communication by the communication unit;
holding resource shortage information in the memory device;
reporting the resource shortage information when the acquiring the memory capacity results in failure;
reading the resource shortage information held in the memory device; and
outputting, as an error, the resource shortage information read in the reading.

8. The method of controlling the information processing apparatus according to claim 7, further comprising:
saving the resource shortage information in a for-whole-system save area when the information processing apparatus performs communication, by using the communication unit, as a server which provides a service on a network or a client which receives the service; and
saving the resource shortage information in a server socket user dedicated save area when the information processing apparatus performs communication as the server.

9. The method of controlling the information processing apparatus according to claim 8, wherein the memory device further comprises:
an information storing area that is used by a kernel of an operating system included in the information processing apparatus.
